(19) United States
(12) Patent Application Publication
(10) Pub. No.: US 2007/0019819 A1
(43) Pub. Date: Jan. 25, 2007

(54) Audio entertainment system

(76) Inventor: Anthony E. Garcia, Stevensons Ranch, CA (US)

Correspondence Address: Owen J. Bates, 1143 Beaconsfield Road, San Jose, CA, 95121, US

(21) Appl. No.: 11/490,468

(22) Filed: Jul. 19, 2006

Related U.S. Application Data
(60) Provisional application No. 60/700,995, filed on Jul. 19, 2005.
(60) Provisional application No. 60/780,000, filed on Mar. 6, 2006.

(51) Int. Cl. H04R 1/10

(52) U.S. Cl. 381/74

(57) ABSTRACT

The present invention relates to a digital audio player which is adapted to output its stored audio content to another media device and receive audio content from the other media device and conduct that audio content to the digital audio player's headphone jack. The invention includes the system of the digital audio player and the other media device.

### RELATED APPLICATIONS

This application claims the benefit of U.S. Provisional Application 60/700,995 filed Jul. 19, 2005 and U.S. Provisional Application 60/780,000 filed Mar. 6, 2006 which is fully incorporated herein by reference.

### BACKGROUND OF THE INVENTION

For a number of years, health clubs and gyms have provided their patrons with various items of exercise equipment. Once aerobic exercise became popular, the gym equipment companies started to manufacture such items as treadmills, stairsteppers, elliptical trainers, and stationary bicycles. One of the focal points of aerobic exercise is to exercise 3 to 5 times a week for a minimum of 30 minutes per workout. Users of such equipment may quickly became bored and look for ways to occupy themselves while putting in their exercise time.

Some users would try to read or perhaps listen to portable radios or audiocassettes. Health club management, in an attempt to cater to this new need of their clients, would provide a series of television monitors mounted in the club. These monitors would be tuned to several different television channels so playing the audio out loud from each monitor simultaneously was not feasible. To solve this problem, the first generation systems were designed so that the corresponding audio for each television channel that was being displayed would be broadcast using short range transmitters on unused broadcast radio frequencies. Signs would be placed on each monitor informing the clientele which radio frequency was being used to transmit the audio for that television monitor. The health club members would bring in their own portable radios and tune their radio to the corresponding frequency for whichever television monitor they wanted to watch.

This system was enhanced by utilizing small audio receiver boxes with volume and channel selectors built-in. These audio receiver boxes would be retrofitted to the desired pieces of workout equipment. The receiver boxes also included standard headphone jacks. To utilize this version, the user would only need to bring their own headphone or purchase one from the gym, which would then be plugged into the jack on the receiver box. The user could, by using the controls on the box, select the audio channel and volume desired. Typically the receiver box would display a monitor number which would be matched up with the same numbered monitor showing the television program that the user was interested in watching.

In the last few years, consumer electronics have made enormous strides in both size and price reduction while at the same time increasing technical capabilities. One of the most popular consumer electronic devices is a Digital Audio Player (DAP). This is a device which stores audio content, typically music, in various digital formats. The players store the digital audio data on internal non-volatile memory chips, removable non-volatile memory cards, miniature hard drives, or other means. The digital audio content that can be downloaded onto the digital audio players can be acquired from various sources. Digitized content be purchased on line, downloaded, and then transferred to the digital audio player. Another source of audio content is from standard commercial CD's. Readily available software allows the audio content of standard music CD's to be copied from the CD, converted to MP3 or other formats and then downloaded to and stored on the DAP. The software that accompanies most DAPs allows various songs and/or tracks to be associated with each other, forming in effect a virtual “album”. This combination of software and DAPs has permitted users to create digital collections of existing and virtual CD's or albums created entirely according to the taste of the user. It should be understood that a reference to “MP3” in this application is meant to include not only the MPEG-1 Audio Layer 3 digital audio encoding and compression format but any and all other digital audio storage and/or compression formats and procedures.

Health club electronics have not kept pace with this advance in consumer electronics. Users who wish to listen to the customized content on their DAPs while at a health club as well as take advantage of the audio content provided by the club must switch their headphones back and forth between their own DAPs headphone jack and the headphone jack provided on the club's audio equipment.

As used herein, headphones refer to a variety of mechanical devices which contain mechanical transducers which convert an electrical analog signal to a mechanical or acoustic wave which can be detected by the human ear and which are designed to hold the transducer in proximity to one or both ears. Headphones can produce acoustic waves for one or both ears and can be positioned next to one or both ears, to cover one or both ears or placed in one or both ear canals. They can be held in place by a variety of mechanical mechanisms including but not limited to those which go over the head, over the ear, in the ear, around the back of the head and under the chin. Though the headphone jacks referenced herein are primarily intended to receive headphones as described above, standard audio speakers which can be designed to be compatible with the electrical signals available at a headphone jack can used as an alternative to the headphones. Therefore references to headphones shall include any transducer which converts electrical signals to mechanical or acoustic signals or in any manner provides for auditory perception by a listener.

By convention, most headphones and headphone jacks utilize a 3.5 mm (miniature) or a 2.5 mm (subminiature) TRS (tip, ring sleeve) type connectors (plug and jack), but any reusable plug and socket can be used to connect a headphone to the DAP or the main module.

It is an object of the present invention to provide an audio entertainment system having a DAP capable of containing audio content which can be placed into communication with a main module attached to, associated with, or built into a piece of health club equipment, a television, radio, or other device. Such an integrated system would permit the user the convenience of listening to a customized collection of audio content stored on the DAP while at the same time, permitting the user to switch to one of the audio sources provided by the main module by a simple manipulation of controls on the main module which would not only permit the selection of audio content provided by main module but also control the selection of audio content on the DAP.

It is another object of the present invention to provide an audio entertainment system having a DAP capable of containing audio content which can be placed into communication with a main module by way of a pair of mating mechanical and electrical connectors, with one component of the mating connectors attached to the DAP and the second mating component of pair attached to the main module.

It is yet another object of the present invention to provide an audio entertainment system having a DAP capable of containing audio content which can be placed into two-way communication with a main module by way of wireless technology.

It is yet another object of the present invention to provide an audio entertainment system having a DAP capable of containing audio content which can be placed in communication with a main module by using wireless technology and mating mechanical and electrical connectors. For example, electrical power might be communicated to the DAP from the main module by a mating pair of electrical mechanical connectors and have other needed communications between the DAP and the main module handled by wireless technologies.

Though discussed herein in the context of utilizing the present invention in a health club, it is within the scope of this invention that it could be used within the passenger cabin of an airplane, buses, limousines, trains, listening rooms in libraries, waiting rooms at doctor's offices, emergency room waiting areas, DMV offices, bar, restaurants, and other locations where distribution of audio content would be desired by the user.

### BRIEF SUMMARY OF THE INVENTION

The present invention is an audio entertainment system which has a main module which is designed to receive via various means various audio signals and connect one of these audio signals to a headphone jack in the main module which will allow a user to hear the audio signals by utilizing a headphone plugged into the headphone jack. The audio signal can also be transmitted wireless to the headphone.

The audio entertainment system also includes a specialized DAP that is a fully functioning standalone DAP which can be inserted into a socket built into the main module. The DAP, when inserted into the socket, will conduct its audio output from the DAP to the main module as one of the audio signals that is received by the main module. A person using the present invention can listen to the audio signal of any of the audio signals provide by the main module including the audio content stored on the DAP. The present invention further conducts the audio signal from the main module that is selected by the user to both the headphone jack in the main module and to the headphone jack in the DAP. When the DAP is inserted into the socket in the main module, the some or all of the functions of the DAP can be controlled from the main module.

The audio entertainment system can also be configured to enhance the usability of the system for the user when the DAP is plugged into the main module. If the user is listening to audio content stored on the DAP and the DAP is plugged into the main module, then the main module will automatically connect the audio output of the DAP to the headphone jack in the main module as well as the headphone jack of the DAP. This enables the user to continue to listen to audio content stored on the DAP in an essentially uninterrupted fashion when the DAP is placed into communication with the main module.

Further, the DAP and the main module can be configured to include wireless technology which would permit the DAP and the main module to transmit back and forth the necessary audio signals and control signals to implement the objectives of the present invention.

The terms “placed into communication”, “attached” and “inserted” all refer to the operation of physically inserting the DAP into the main module and/or bringing the DAP into close enough physical proximity to the main module that wireless technology can effectuate the transfer of information and control signals back and forth between the DAP and the main module.

The terms “communicate”, “transmit”, “receive”, “conduct” all refer to the process of passing information back and forth, by direct electrical connection or by wireless technology the audio signals and control signals necessary to effectuate the objectives of the invention.

As used herein, “audio signals” refers to both analog and digital signals capable of transmitting audio content. Ultimately, for auditory perception by a listener, the signal must be converted to a mechanical analog signal, but prior to that point, any combination of analog and digital signals in any form may be transmitted and switched by the DAP, the main module and their internal components.

### BRIEF DESCRIPTION OF THE SEVERAL VIEWS OF THE DRAWINGS

Having just described the invention in general terms, other and further objects, features, and advantages of the invention will be more explicit from the following detailed description taken with reference to the drawings, which are not necessarily drawn to scale, and wherein:

FIG. 1 is a schematic diagram of the present invention;

FIG. 2 is layout for one possible keyboard for the main module of the present invention;

FIG. 3 is perspective view of one embodiment of the present invention; and

FIGS. 4 and 5 are two perspective views of one possible embodiment of the DAP of the present invention

### DETAILS OF ONE PARTICULAR EMBODIMENT

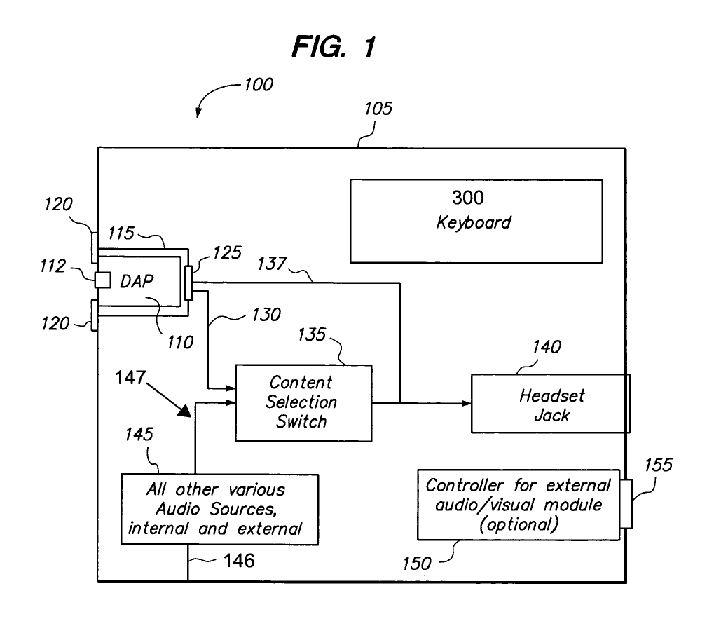

One particular embodiment of the present invention is shown schematically in FIG. 1. Audio Entertainment System 100 is comprised of Main Module 105 and Digital Audio Player (DAP) 110. DAP 110 is designed to be physically and electrically reversibly attachable to Main Module 105. Although this attachment is shown schematically in FIG. 1 and discussed below, by DAP 110 being positioned within Socket 115 located in Main Module 105, any number of means of physically and/or electronically attaching DAP 110 to Main Module 105, both wired and wireless, are well known in the art. Wireless technologies shall be understood to include but not be limited to such technologies as Wi-Fi (IEEE 802.11 specification), Bluetooth (IEEE 802.15.1 specification), propriety radiofrequency and/or microwave frequency technologies as well as infrared frequency technologies.

In addition, such attachment could be configured to include a combination of one or more mating electrical mechanical connectors as well as one or more wireless technologies. A typical combination attachment would conduct power from the Main Module 105 to the DAP 110 by use of mating electrical mechanical connectors and communicate audio content from the DAP 110 to the Main Module 105 and vice versa by wireless technology. With such a configuration, the DAP 110 might be located in sufficient proximity to the Main Module 105 that wireless communication can be accomplished without being physically inserted into the Main Module 105. In such a situation, the DAP 105 would continue to operate on its own internal power source.

A second combination attachment could include a duplex system. The DAP 105 would be configured with a full wireless communication capability as well as a mating mechanical electrical connector which is adapted to communicate all the necessary audio signals, controls signals and electrical power. Such a system would provide the user with the option to attach the DAP 110 to the Main Module 105 using the built-in wireless communication functions or if for some reason, the wireless communication wasn't working, the DAP 105 can be inserted into the Main Module 105 and communication be accomplished by wired connections through Mating Connector Pair 125.

DAP 110 is shown being held in place within Socket 115 by Retaining Tabs 120. Any number of other mechanisms which would physically and electrically releasably retain DAP 110 in Socket 115 are well known in the art. Electrical communication between DAP 110 and Main Module 105 is accomplished by the use of Mating Connector Pair 125, which is a pair of mating electrical connector components, one each mounted in DAP 110 and Main Module 105. Mating Connector Pair 125 mates electrical signals and voltages to and from DAP 110 to Main Module 105 when DAP 110 is fully inserted into Socket 115.

DAP 110 is a fully functioning standalone digital audio player even when not inserted in Main Module 105. At a minimum, this means that DAP 110 has its own source of electrical power or a means to receive electrical power, a means to store audio content in a digital form, a means to convert the digital form of the audio content to an audio signal, and to convey that audio signal to a headphone jack, a speaker or other means to typically create an acoustic wave or any other auditory perceivable signal. Additional features can include but are not limited to a communications link to transfer digital content to and from the DAP 110, various user controls including but not limited to volume controls, content selection controls, and a display screen or some form of visual indicator to provide information to the user.

In addition to the functions described above, DAP 110 might include other electronic functionalities including but not limited to one or more, of a CD player, audio tape player, clock, watch, calendar, cell phone, AM radio, FM Radio, satellite radio receiver, pager, and personal digital assistant,

One of the electrical signals conducted by Mating Connector Pair 125 is the Audio Output 130 from DAP 110. This audio signal is conducted by appropriate wiring to an audio input of Content Selector Switch (CSS) 135. CSS 135 will electrically conduct at least one of the audio inputs to at least one output which is conducted to Main Module Headphone Jack 140. Main Module Headphone Jack 140 is mounted on one of the external surfaces of Main Module 105 so that it is accessible by users of the Audio Entertainment System 100. The at least one of the audio outputs of CSS 135 is also routed back to DAP 110 and then onto DAP Headphone Jack 112 via Conductor 137 and Mating Connector Pair 125. Thus at least one of the selected audio inputs, which is one of the outputs CSS 135 can either be heard by connecting a headphone to DAP Headphone Jack 112 or to Main Module Headphone Jack 140. Optionally, at least one of the outputs of CSS 135 can also be transmitted wirelessly to a receiving device, not shown.

When DAP 110 is attached to Main Module 105, the DAP 110 can detect this attachment and then cause the DAP Headphone Jack 112 to be electrically disconnected from the local audio output of DAP 110. The disconnection of DAP Headphone Jack 112 can also be initiated by establishing of a wireless communication link with the Main Module 105 if wireless communication capability is included. Then one of the at least one audio outputs of CSS 135 is automatically connected to the DAP Headphone Jack 112 of DAP 110. If DAP 110 is playing its own stored audio content just prior to attachment into Main Module 105, then CSS 135 will automatically select the audio output of DAP 110, which is conducted as an input to CSS 135 over Audio Output 130, as one of the outputs of CSS 135 and which then conducts the output of DAP 110 to Main Module Headphone Jack 140 in Main Module as well as the DAP Headphone Jack 112.

Therefore, if a user is listening to audio content from DAP 110 on a headphone connected to DAP Headphone Jack 112 of DAP 110 and then places DAP 110 into communication with Main Module 105, the user will continue to hear, with essentially no interruption, the same audio content from the DAP Headphone Jack 112 of DAP 110 after establishing communication between DAP 105 and Main Module 105. Thus the user does not have to switch his headphone back and forth between the headphone jacks of DAP 110 and Main Module 105. He can leave his headphone plugged into DAP Headphone Jack 112, establish communication between DAP 110 and Main Module 105, and continue to listen to content stored on DAP 110 or switch to any of the audio content made available on Main Module 105. When the user is finished, he simply removes DAP 110 from Main Module 105 or otherwise breaks communication between DAP 110 and Main Module 105, with the headphone still plugged into DAP Headphone Jack 112, and be able to go back to listening to the audio content on DAP 110.

Other Audio Content 145 is comprised of any number of audio sources other than the audio obtained from DAP 110. Though shown in FIG. 1 as a single Connector 147, in fact each individual audio source is connected by appropriate wiring and/or conductors or electronics to a separate input of CSS 135. Though shown in FIG. 1 as a separate module, CSS 135 could be included as an integral part of one or more of the electrical circuits that are included in Main Module 105.

Examples of possible Other Audio Sources 145 are now described disclosed.

Short Range FM Transmitters

This is similar to the earlier wireless transmitters used by clubs to transmit television audio channels to the dedicated receivers. This is designed to be used in health clubs where shared centrally mounted monitors and audio transmitters are still in use. In a fashion similar to their earlier use, the health club patron would use the controls on the Main Module to select an audio channel that corresponds to the program the is being shown on one of the numbered shared monitors. These transmitters are typically tuned to a locally available, that is, unused FM frequency.

Because the Main Module 105 may need to be backwards compatible with existing systems, the Main Module may include the ability to receive transmissions 900 MHz and/or 863 MHz which are authorized frequencies in the United States, Europe, and other parts of the world. However, the Short Range Transmitters can also include other FCC approved frequencies that design requirements might dictate

In addition, if AM/FM reception is poor inside the club, special equipment, including antennas and high gain receivers could be used to pick up a good broadcast signal and then retransmit that signal over the 900 MHz/863 MHz frequencies. The problem with this system is that you can only receive and therefore retransmit one broadcast station at a time. Each additional simultaneously available radio program would require another set of receiver/amplifier equipment, which would increase costs.

In addition to the radio broadcast content, local audio and computer equipment could be provided to generate audio output from CD's, DVD's, internet webcasts, podcasts, and other sources of audio content. This locally generated audio content could be included on one of the 900 MHz/863 MHz frequencies.

Audio content that could be transmitted over the 900/863 MHz frequencies can also be acquired by the Club by signing up for subscription services such as DMX, Muzak, and Music Choice. In addition, audio content from satellite radio broadcasters, such as could be licensed and carried on one of the 900/863 MHz frequencies.

AM/FM Receiver

As an alternative to having the Main Module 105 receiving AM/FM radio programs over the 900/863 MHz frequencies, the Main Module could be equipped with its own AM/FM receiver. This option would only be feasible if the AM/FM band signals were strong enough inside the building or equipment such as active and/or passive antenna/repeaters are used to boost the AM/FM signal within the building.

Satellite Radio Receiver

Presently there are two major satellite radio broadcasting companies, Sirius and XM. Programs from around the world are broadcast directly to handheld receivers from orbiting satellites. The Main Module could be adapted with another Attachment Mechanism similar to that used for the DAP. This second Attachment Mechanism would physically and electronically interface the Satellite Radio Receiver (SRR) to the Main Module. The output of the SRR would be connected as one of the inputs to the Audio Selector Switch.

Like the DAP, the SRR is a fully contained and operational device when detached from the Main Module. When attached to the Main Module, the SRR can obtain operating voltage from the Main Module and it connects the audio output from the SRR through the second Attachment Mechanism, and ultimately to the CSS 135. If an SRR is attached to Main Module 105, then the output of the CSS 135 would be conducted back to the headset jack of the SRR.

References to a SRR are meant to include all currently available satellite transmission protocols and services as well as those transmission protocols and services that may be developed or available in the future.

Audio for Cable Television Channel

One direction that a number of clubs are taking, in order to provide entertainment as personalized as possible, is to attach televisions with LCD displays to each piece of work out equipment. This enables each user to select any particular audio and video channel that is available. Both video and audio content is usually delivered to the televisions via co-axial cable. The television units are either mounted on or are freestanding and placed in close proximity to each individual pieces of workout equipment and are designed to be controlled by a separate remote command control module.

Controller 150 is an optional remote control module for an external non-shared LCD/TV associated with the same piece of exercise equipment as Audio Entertainment System 100. By sending command control signals to the LCD/TV, channel selection can be made. The audio for the selected TV channel is also connected to CSS 135 as one of the External Inputs 146. External Inputs 146 are any of the Other Audio Sources 145 which are conducted to CSS 135 of Main Module 105 over any type of cable, wire, fiber or conductor. The command and control signals sent by Controller 150 are controlled by user input to Keyboard 300 which is the interface between the user and the Main Module 105. Infrared command and control signals are sent from IR Remote 155 which is mounted so that the IR command and control signals can be received by the LCD/TV.

User controls on Keyboard 300 would typically include and UP CHANNEL and DOWN CHANNEL select buttons. All of the actual television electronics are part of the LCD unit and only command control signals are sent from the Main Module via IR Remote 155 to the LCD unit to control selection of the channel to be displayed. The audio signal from the selected channel on the LCD/TV will be routed back to the Main Module and from there to the CSS 135.

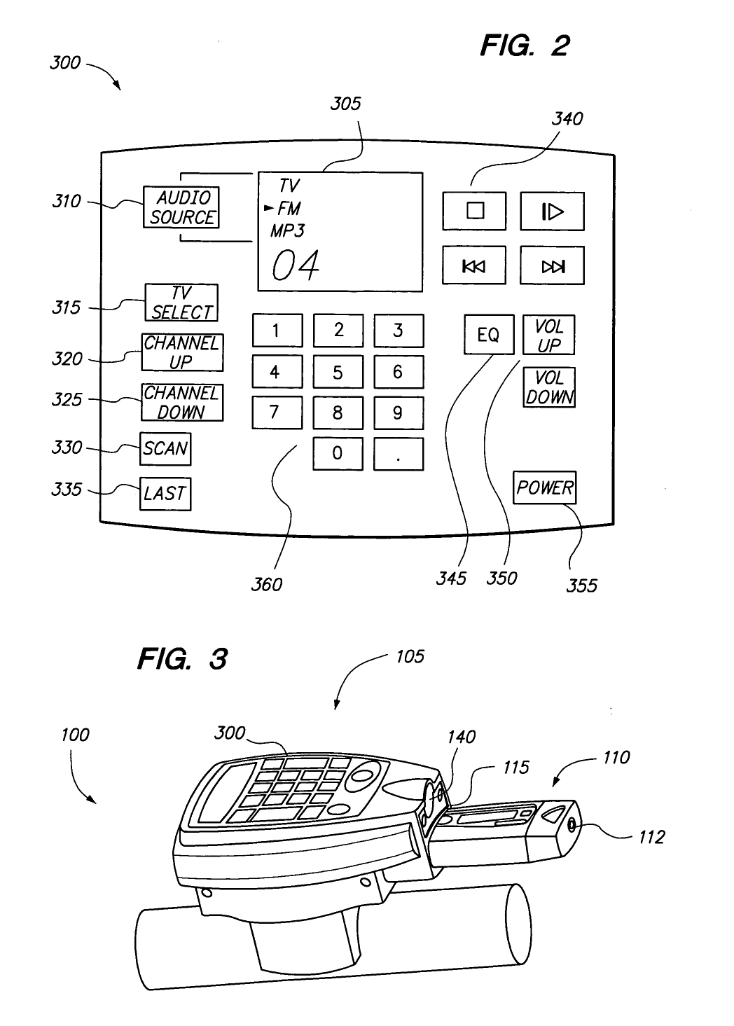

CSS 135 is also controlled by Keypad 300. One example of many possible configurations for Keypad 300 is shown in FIG. 2. Display 305 shows information to the user about which audio or TV channel has been selected. The user presses Audio Source Selector Button 310 until the desired audio source is shown visually marked in Display 305. The number and type of audio sources shown on Display 305 will be dependent upon which particular audio sources have been implemented for a particular Main Module 105 based upon the needs and requirements of a particular installation location. The FM audio source is shown as being selected in the FIG. 2. The FM source is shown as selected by the display of a triangle with one of the vertices of the triangle pointed at the letters “FM”. Any number of possible graphical devices can be used to indicate which of the possible audio sources is selected and is the audio source connected to the Main Module Headphone Jack 140 and/or DAP Headphone Jack 112. Each time Audio Source Selector Button 310 is pressed, Display 305 changes to show the next audio source in the sequence as being selected. The Main Module will electronically connect the selected audio source to the DAP and Main Module Headphone Jacks 112 and 140 by activation of CSS 135. Display 305 can be modified to display any additional and/or different audio sources that a particular Main Module has been adapted to receive.

If a personal LCD is part of a particular system, then Keypad 300 will include TV Select Button 315. After TV Select Button 315 has been pressed, the user can press Channel Up Button 320 or Channel Down Button 325 in order to select the desired TV channel. This causes a command control signal to be sent from Controller 150 to the external LCD TV display so that the selected channel will be displayed. Alternatively, the user can enter the number of the desired channel on Numeric Keypad 360. When the external LCD TV display switches channels, the appropriate audio channel for the external LCD TV is connected to one of the External Inputs 146 which is then selected by the CSS 135 so that the user hears the appropriate audio channel for the TV channel which is now being displayed. However, once the LCT/TV is switched to a specific channel, the audio can then be switched to one of the other audio sources.

Scan Button 330 allows the user to scan the available FM audio sources. Depending on how a particular club has configured the system, the scan button will go through all available FM audio sources or it will cycle through a subset of FM audio source preselected by the club. FM audio sources can include the short range TV audio sources transmitted over locally unused FM broadcast frequencies, various audio sources broadcast over the 900/863 MHz frequencies or an internal FM receiver. Last Button 335 operates in manner similar the Last button on a standard home TV or cable remote. It cycles between the present audio source and the most recent previously selected audio source or TV channel. In that way a user may go back and forth between, for example, a TV channel and FM radio channel or simply back and forth between two selected TV channels.

If the MP3 audio source is selected then the DAP Control Panel 340 is active. DAP Control Panel 340 is a cluster of 4 buttons which allow the user to play, pause, go forward and go backwards through tracks and/or songs that are digitally stored on the DAP.

Equalizer Button 345 allows the user to cycle between a number of pre-set equalized tones with each tone named to correspond to the particular equalized tone. For example, tones might be named: bass, treble, mid, or flat. The tone name selected will be displayed on the Display 305.

Volume Button 350 allows the volume of the audio signal that appears at the headphone jacks to be set louder or softer. Volume Button 350 will control volume on both DAP Headphone Jack 112 and Main Module Headphone Jack 140. Power Button 355 turns electrical power on and off to all functions of the Main Module 105.

FIG. 3 shows a perspective view of the Audio Entertainment System 100 mounted on a bar which would typically be a component of a piece of exercise equipment or other hardware. DAP 110 is shown partially inserted into Socket 115. DAP Headphone Jack 112 is located on the outside surface of DAP 110 so that it is available to the user when DAP 110 is fully inserted into Socket 115. Main Module Headphone Jack 140 is positioned along the front surface of Main Module 105 so that it is readily available to a user if DAP 110 is not being used. Main Module Headphone Jack 140 is part of a diagnostic replaceable headphone jack assembly.

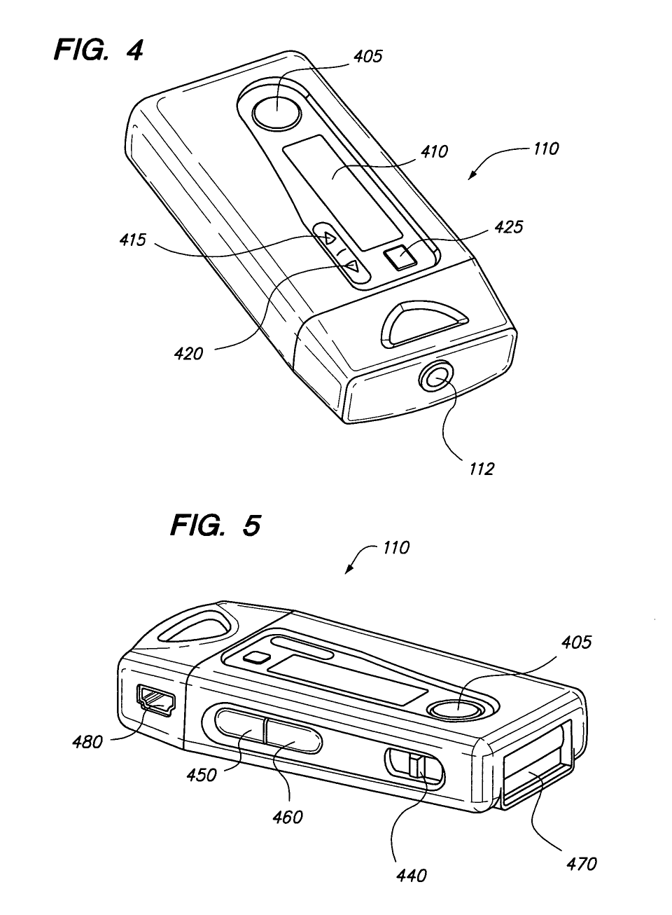

FIGS. 4 and 5 show two perspective views of DAP 110. Power Button 405 turns on power to the DAP 110 which comes from a AAA battery housed inside DAP 110, which isn't shown. Other forms and/or types of power sources are well known in the art and could be used. When DAP 110 is plugged into the Main Module 105, the internal power source is disconnected and the DAP 110 runs off of energy supplied by the Main Module 105 as conducted via Mating Connector Pair 125.

Display 410 is an LCD display which provides information to the user regarding the status of the player and other information.

Buttons 415 and 420 are Skip Forward and Skip Backwards function buttons which allow the user to skip over the existing audio selection and go forwards or backwards to the next audio selection.

Mode Button 425 allows the user to select various repeat modes. Either the existing selection will be repeated when it ends or the player will cycle through all of the selections stored on it and then repeat once they have all been played.

Button 440 is a hold button which disables all of the function keys and leaves the DAP 110 in whatever functional state it was in. This function prevents the accidental pressing of keys, for example, while excising, running or other physical activity.

Buttons 450 and 460 are volume up and volume down controls for the audio content.

Connector 470 is one half of Mating Connector Pair 125. Connector 470 is mounted in one end of DAP 110. When DAP 110 is inserted into Socket 115, Connector 470 mates with Connector 475 (not shown) which is located within Main Module 105 at the bottom of Socket 15. When Connector 470 and 475 are mated various analog and digital signals and voltages can be conducted between the DAP 110 and the Main Module 105.

Port 480 is a communications port which allows the user to download or upload digital files that are stored on the DAP. Typically this is a universal serial bus (USB) connector, though others known connectors and protocols for transferring digital information could be used.

Though not shown, other functionalities can be incorporated into DAP 110, such as the ability to utilize playlists and selection of audio tracks by title, artist, genre, and other parameters. Additional control hardware to access such functionality would be incorporated as needed.

To those skilled in the art it will be understood that there can be many other variations of the embodiments what have been described above while still achieving the same objectives of the invention. Such variations are intended to be covered by the scope of this invention. As such, the foregoing description of embodiments of the invention is not intended to be limiting. Accordingly, it is intended that the appended claims will cover all modifications of the invention that fall within the true spirit and scope of the invention.

What is claimed is:

1. An entertainment system comprising:
a main module having a headphone jack, said main module further comprising one or more audio inputs adapted to receive one or more audio signals; an audio input selector means adapted to receive said audio signals from said audio inputs and further adapted to conduct one of said audio signals to said main module headphone jack;
a fully functioning stand alone digital audio player having a headphone jack adapted to receive the audio output of said digital audio player; and
said digital audio player and said main module are adapted to be placed in communication with each other; and when said digital audio player and said main module are in communication with each other
a) said main module can receive and said digital audio player can transmit the audio output of said digital audio player to said audio input selector means of said main module; and
b) said main module can transmit and said digital audio player can receive the audio output of said audio input selector means, transmit said audio output of said audio input selector means to said headphone jack of said digital audio player and said headphone jack of said digital audio player is disconnected from said audio output of said digital audio player.

2. An entertainment system as described in claim 1 wherein said main module is adapted to reversibly receive, physically and electrically said digital audio player, whereby
said main module can receive and said digital audio player can transmit the audio output of said digital audio player to said audio input selector means of said main module; and
said main module can transmit and said digital audio player can receive the audio output of said audio input selector means, transmit said audio output of said audio input selector means to said headphone jack of said digital audio player and said headphone jack of said digital audio player is disconnected from said audio output of said digital audio player.

3. An entertainment system as described in claim 1 wherein said transmission and receipt of said audio output and audio content is wirelessly transmitted.

4. An entertainment system as described in claim 1 wherein said main module is further adapted to receive audio signal from one or more audio signals selected from the group consisting of commercial AM broadcast stations, commercial FM broadcast stations, short range FM broadcasts, short range 900 MHz transmissions, short range 863 MHz transmissions, and commercial broadcast television audio signals.

5. An entertainment system as described in claim 1 further comprising a wireless transmission means for transmitting said audio output of said audio input selector means.

6. An entertainment system as described in claim 1 further comprising a TV controller, said TV controller adapted to send a control signal to a television to cause the television to display the selected television station.

7. An entertainment system as described in claim 1 wherein said entertainment system is adapted to be physically attached to a piece of exercise equipment.

8. An entertainment system as described in claim 1 wherein said main module conducts DC voltage to said digital audio player and said digital audio player is disconnected from its internal power source when said digital audio player is reversibly, physically and electrically attached to said main module.

9. An entertainment system as described in claim 1 wherein all functions of said digital audio player are controllable by signals transmitted from said main module when said digital audio player and said main module are in communication with each other.

10. An entertainment system as described in claim 1 wherein said digital audio player is further adapted to transfer digital audio information stored on said digital audio player to said main module and said main module is further adapted to receive said digital audio files; said main module further adapted to convert said digital audio files to an analog audio signal and conduct the audio signal to the audio input selector means of said main module.

11. An entertainment system as described in claim 5 wherein said wireless transmitter is compliant with the IEEE 802.15.1 standard.

12. An entertainment system as described in claim 1 wherein said main module further comprises an integral AM radio receiver wherein said audio output from said AM radio receiver is connected to said audio input selector.

13. An entertainment system as described in claim 1 wherein said main module further comprises an integral satellite-transmitted digital radio receiver wherein said audio output from said satellite-transmitted radio receiver is connected to said audio input selector.

14. An entertainment system as described in claim 13 further comprising a wireless radio receiver adapted to receive audio content transmitted from a satellite; said wireless radio received adapted to be reversibly physically and electrically attachable to said main module.

15. An entertainment system as described in claim 14 wherein said wireless radio receiver is adapted to be fully operable when detached from said main module.

16. A fully functioning stand alone digital audio player adapted to be placed into communication with a main module wherein said digital audio player is adapted to connect the audio output of said digital audio player to the second module and receive an audio signal from said second module; said received audio signal being further conducted to said headphone jack of said digital audio player.

17. digital audio player as described in claim 16 wherein said digital audio player is adapted to receive a direct current voltage from said main module when said digital audio player is physically and electrically attached to said second module.

18. A digital audio player as described in claim 16 wherein said internal power source of said digital audio player is disconnected from the digital audio player when said digital audio player is physically and electrically attached to said main module.

19. A digital audio player as described in claim 16 wherein all functions of said digital audio player are controllable by signals generated from the main module.

20. A digital audio player as described in claim 16 wherein said audio output of said digital audio player is disconnected from the headphone jack of the digital audio player when said digital audio player is placed into communication with said main module.
